(19) United States
(12) Patent Application Publication
(10) Pub. No.: US 2026/0028030 A1
(43) Pub. Date: Jan. 29, 2026

(54) DRIVER MONITORING DEVICE, DRIVER MONITORING METHOD, AND STORAGE MEDIUM

(71) Applicant: HONDA MOTOR CO., LTD., Tokyo (JP)

(72) Inventors: Satoru Shinkawa, Wako-shi (JP); Shigenobu Mitsuzawa, Wako-shi (JP); Hiroshi Ono, Wako-shi (JP); Hiroki Taniguchi, Wako-shi (JP); Nozomi Nagatani, Wako-shi (JP)

(21) Appl. No.: 19/212,981

(22) Filed: May 20, 2025

(30) Foreign Application Priority Data
Jul. 26, 2024 (JP) 2024-121019

(51) Int. Cl. B60W 40/09; B60W 50/14

(52) U.S. Cl. CPC B60W 40/09; B60W 50/14; B60W 2400/00; B60W 2556/50

(57) ABSTRACT

A driver monitoring device includes: a biometric information recognition portion that recognizes biometric information of a driver of a moving body; a driving behavior recognition portion that recognizes driving behavior of the driver, who is driving; a driving risk recognition portion that recognizes, using a predetermined recognition method, a driving risk indicating a risk level of movement of the moving body due to driving of the driver, based on at least one of the biometric information of the driver and the driving behavior of the driver, when the driver is driving the moving body; and a driving risk recognition method switching portion that switches the recognition method used when the driving risk recognition portion recognizes the driving risk at a next recognition timing, according to the driving risk recognized by the driving risk recognition portion.

### INCORPORATION BY REFERENCE

The present application claims priority under 35 U.S.C. § 119 to Japanese Patent Application No. 2024-121019 filed on Jul. 26, 2024. The content of the application is incorporated herein by reference in its entirety.

### BACKGROUND OF THE INVENTION

### Field of the Invention

The present invention relates to a driver monitoring device, a driver monitoring method, and a storage medium.

### Description of the Related Art

In recent years, approaches have been actively made to provide access to sustainable transportation systems that take into consideration even vulnerable traffic participants. To achieve this, efforts have been focused on research and development into preventive safety technology to further improve traffic safety and convenience.

For example, a technique is disclosed in Japanese Patent Laid-Open No. 2019-61480 that calculates a drowsiness risk of a driver based on information obtained from the driver of a vehicle, calculates a monotonous driving risk based on information regarding a traveling route of the vehicle, and estimates a time at which a future drowsiness level of the driver exceeds a predetermined threshold, based on the drowsiness risk and the monotonous driving risk.

In preventive safety technology, it is effective for the driver, who is driving a moving body, to recognize the degree of risk of a driving situation with which the driver is confronted and to take necessary measures, but there is a demand for reducing power consumption accompanied by the recognition of the degree of risk. Therefore, an object of the present invention is to recognize the degree of risk of the driving situation with which the driver is confronted, while reducing power consumption.

In order to solve the above problems, the present invention aims to recognize the degree of risk of the driving situation with which the driver is confronted, while reducing power consumption. Thus, this further improves traffic safety and contributes to the development of a sustainable transportation system.

### SUMMARY OF THE INVENTION

A first aspect of the present invention for achieving the above object provides a driver monitoring device including: a biometric information recognition portion that recognizes biometric information of a driver of a moving body; a driving behavior recognition portion that recognizes driving behavior of the driver, who is driving the moving body; a driving risk recognition portion that recognizes, using a predetermined recognition method, a driving risk indicating a risk level of movement of the moving body due to driving of the driver, based on at least one of the biometric information of the driver recognized by the biometric information recognition portion and the driving behavior of the driver recognized by the driving behavior recognition portion, when the driver is driving the moving body; and a driving risk recognition method switching portion that switches the recognition method used when the driving risk recognition portion recognizes the driving risk at a next recognition timing, according to the driving risk recognized by the driving risk recognition portion.

In the driver monitoring device, the driving risk recognition portion may recognize a pre-driving risk, which is the driving risk before the driver starts driving the moving body, based on the biometric information of the driver recognized by the biometric information recognition portion before the driver starts driving the moving body, and the driving risk recognition method switching portion may switch the recognition method based on the pre-driving risk.

In the driver monitoring device, the driving risk recognition method switching portion may switch the recognition method to a first recognition method of recognizing the driving risk based on the biometric information of the driver without using the driving behavior of the driver when the driving risk recognized by the driving risk recognition portion is equal to or smaller than a first determination value, and the driving risk recognition method switching portion may switch the recognition method to a second recognition method of recognizing the driving risk based on the driving behavior and the biometric information of the driver when the driving risk recognized by the driving risk recognition portion is greater than the first determination value.

In the driver monitoring device, the driver monitoring device may further include a driving risk notification portion that outputs a predetermined notification from an output device used by the driver when the driving risk recognition portion recognizes the driving risk that is greater than a first notification threshold.

In the driver monitoring device, the driver monitoring device may further include: a moving body position recognition portion that recognizes a position of the moving body; and a movement history recognition portion that recognizes a former movement history of the moving body, and the driving risk recognition portion may recognize the driving risk that is equal to or smaller than the first determination value, and may increase a frequency of recognizing the driving risk when the moving body position recognition portion recognizes that the moving body is approaching a target position where the movement history recognition portion recognizes that the moving body formerly exhibited predetermined unstable behavior.

In the driver monitoring device, the driver monitoring device may further include: a moving body position recognition portion that recognizes a position of the moving body; and a movement history recognition portion that recognizes a former movement history of the moving body, and the driving risk recognition method switching portion may switch the recognition method to the second recognition method when the driving risk recognition portion recognizes the driving risk that is equal to or smaller than the first determination value and the moving body position recognition portion recognizes that the moving body is approaching a target position where the movement history recognition portion recognizes that the moving body formerly exhibited predetermined unstable behavior.

In the driver monitoring device, the driving risk recognition method switching portion may switch, when the driving risk recognition portion recognizes the driving risk equal to or greater than a second determination value that is greater than the first determination, the recognition method to a third recognition method in which the driving risk is recognized based on the biometric information and the driving behavior of the driver and in which a frequency at which the biometric information recognition portion recognizes the biometric information of the driver and a frequency at which the driving behavior recognition portion recognizes the driving behavior of the driver are higher than those in the second recognition method.

In the driver monitoring device, driver monitoring device may further include a surrounding condition recognition portion that recognizes a surrounding condition of the moving body based on a result detected by an external sensor provided in the moving body, and the third recognition method may recognize the driving risk based on the surrounding condition of the moving body recognized by the surrounding condition recognition portion.

In the driver monitoring device, when the driving risk recognized by the driving risk recognition portion is equal to or greater than a second notification threshold that is greater than the first notification threshold, the driving risk notification portion may output the predetermined notification from the output device at a higher frequency than when the driving risk recognized by the driving risk recognition portion is smaller than the second notification threshold.

In the driver monitoring device, when the driving risk recognized by the driving risk recognition portion is equal to or greater than a second notification threshold that is greater than the first notification threshold, the driving risk notification portion may output the predetermined notification from the output device provided in the moving body.

A second aspect of the present invention for achieving the above object provides a driver monitoring method executed by a computer, the driver monitoring method including: a biometric information recognition step of recognizing biometric information of a driver of a moving body; a driving behavior recognition step of recognizing driving behavior of the driver, who is driving the moving body; a driving risk recognition step of recognizing, using a predetermined recognition method, a driving risk indicating a risk level of movement of the moving body due to driving of the driver, based on at least one of the biometric information of the driver recognized in the biometric information recognition step and the driving behavior of the driver recognized in the driving behavior recognition step, when the driver is driving the moving body; and a driving risk recognition method switching step of switching the recognition method used when the driving risk is recognized at a next recognition timing in the driving risk recognition step, according to the driving risk recognized in the driving risk recognition step.

A third aspect of the present invention for achieving the above object provides a program causing a computer to function as: a biometric information recognition portion that recognizes biometric information of a driver of a moving body; a driving behavior recognition portion that recognizes driving behavior of the driver, who is driving the moving body; a driving risk recognition portion that recognizes, using a predetermined recognition method, a driving risk indicating a risk level of movement of the moving body due to driving of the driver, based on at least one of the biometric information of the driver recognized by the biometric information recognition portion and the driving behavior of the driver recognized by the driving behavior recognition portion, when the driver is driving the moving body; and a driving risk recognition method switching portion that switches the recognition method used when the driving risk recognition portion recognizes the driving risk at a next recognition timing, according to the driving risk recognized by the driving risk recognition portion.

According to the driver monitoring device, the driver monitoring method, and the storage medium, it is possible to recognize a risk level of a driving situation with which the driver is confronted, while reducing power consumption.

### BRIEF DESCRIPTION OF THE DRAWINGS

FIG. 1 is an explanatory diagram of a usage mode of a driver monitoring device;

FIG. 2 is a configuration diagram of the driver monitoring device;

FIG. 3 is an explanatory diagram illustrating a corresponding relationship between life habit data, driving-related abilities, and driving diagnosis indices for coaching;

FIG. 4 is a flowchart of a process calculating a predicted risk score; and

FIG. 5 is an explanatory diagram of a concept of a predicted risk score.

### DETAILED DESCRIPTION OF THE INVENTION

### 1. Usage Mode of Driver Monitoring Device

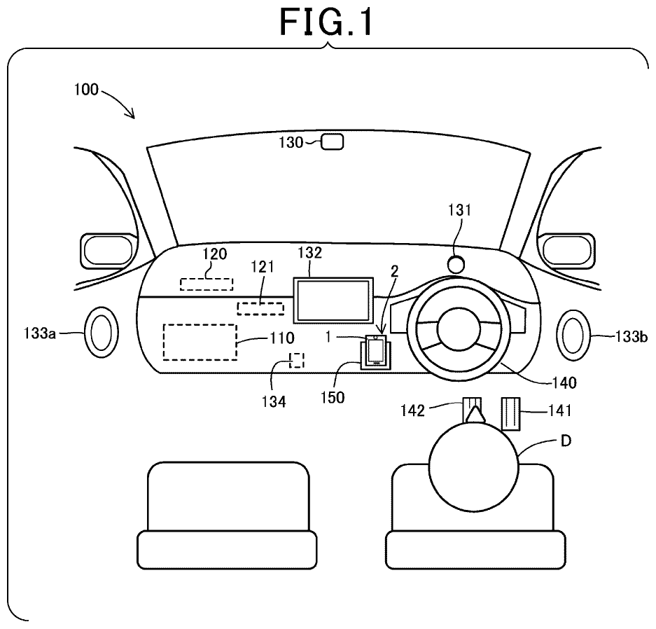

A usage mode of a driver monitoring device 2 according to the present embodiment will be described with reference to FIG. 1. The driver monitoring device 2 is configured as a function of a communication terminal 1 used by a driver D of a vehicle 100. The communication terminal 1 is a smartphone, a mobile phone, a tablet terminal, or the like. The communication terminal 1 is attached to a terminal holder 150 provided in the vehicle 100. The vehicle 100 corresponds to a moving body of the present disclosure. The moving body of the present disclosure may be an aircraft, a ship, or the like other than the vehicle.

The vehicle 100 includes, for example, an electronic control unit (ECU) 110 that controls an operation of the vehicle 100, a communication unit 120, a navigation device 121, a front camera 130 that captures an image of a front side of the vehicle 100, a driver monitor camera 131 that captures an image of the driver D, a display 132, speakers 133a and 133b, and an acceleration sensor 134. The ECU 110 communicates with the communication terminal 1 via the communication unit 120. The vehicle 100 includes, as driving operation portions, a steering wheel 140, an accelerator pedal 141, and a brake pedal 142.

The driver monitoring device 2 recognizes the operation (driving behavior) of the steering wheel 140, the accelerator pedal 141, and the brake pedal 142 by the driver D by receiving operation information through communication with the ECU 110, or by detection information from the acceleration sensor built into the communication terminal 1. The driver monitoring device 2 acquires biometric information (for example, heart rate) of the driver D measured by a wearable device worn by the driver D, through communication with the wearable device.

Then, the driver monitoring device 2 calculates, based on the driving behavior and the biometric information of the driver D, a predicted risk score indicating a risk level for the movement of the vehicle 100 by the driving of the driver D after a predetermined point of time when the driving behavior and the biometric information are recognized. The higher the risk level, the larger the value of the predicted risk score. Furthermore, the driver monitoring device 2 gives advice to the driver D according to the level of the predicted risk score and supports the movement of the vehicle 100 by the driving of the driver D.

### 2. Configuration of Driver Monitoring Device

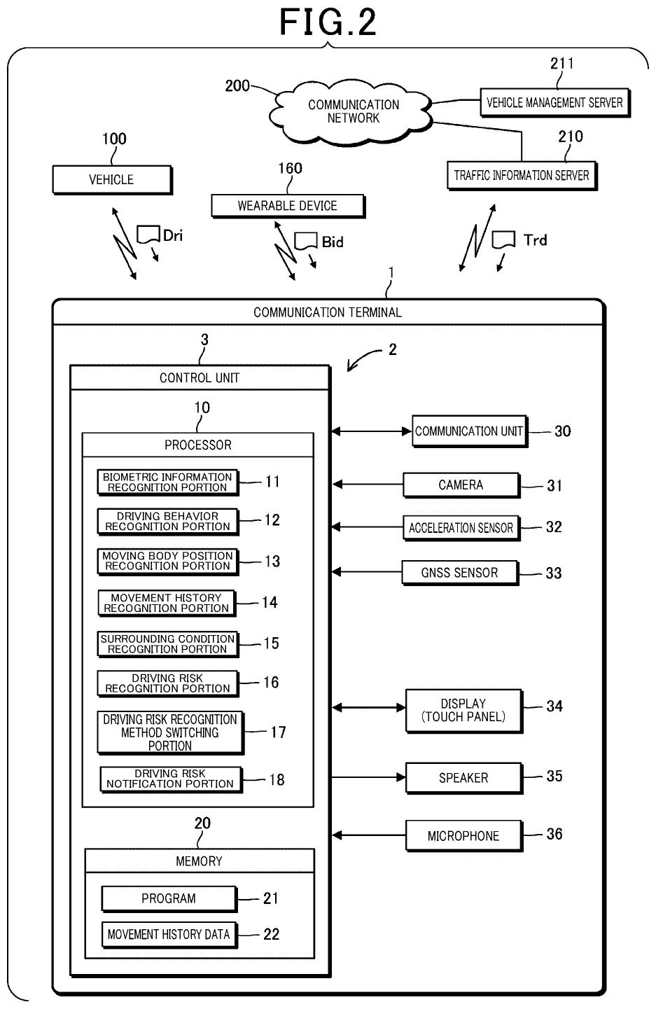

A configuration of the driver monitoring device 2 will be described with reference to FIG. 2. The communication terminal 1 having functions of the driver monitoring device 2 includes a control unit 3 including a processor 10 and a memory 20, a communication unit 30, a camera 31, an acceleration sensor 32, a global navigation satellite system (GNSS) sensor 33, a display 34, a speaker 35, and a microphone 36.

The communication unit 30 includes a transmitter and a receiver and performs near-field wireless communication between the vehicle 100 (specifically, the ECU 110 mounted on the vehicle 100) and a wearable device 160 (for example, a smart watch, wearable smart underwear, or a sensing device attached to the body or skin) worn by the driver D, using specifications of Bluetooth (registered trademark) and UWB (Ultra-Wide Band). The communication unit 30 communicates with a traffic information server 210, a vehicle management server 211, and the like via a communication network 200.

The camera 31 captures an image of the driver D in a state where the communication terminal 1 is attached to the terminal holder 150 (see FIG. 1). The acceleration sensor 32 detects, for example, six axes (acceleration in each of front-rear, left-right, and up-down axial directions, and an angular velocity of each axis). The GNSS sensor 33 detects a position of the communication terminal 1. The position detected by the GNSS sensor 33 in a state where the communication terminal 1 is attached to the terminal holder 150 becomes a current position of the vehicle 100. The display 34 is a touch panel, and the driver D touches the display 34 to instruct the driver monitoring device 2 to use or stop functions thereof.

The memory 20 stores a program 21 for an application of the driver monitoring device 2 and movement history data 22. The movement history data 22 is recorded with information on movement history of the vehicle 100 (for example, a travel route of the vehicle 100, and a place where the vehicle 100 behaves instable) based on the position of the vehicle 100 detected by the GNSS sensor 33.

The Processor 10 reads and executes the program 21, and thus functions as a biometric information recognition portion 11, a driving behavior recognition portion 12, a moving body position recognition portion 13, a movement history recognition portion 14, a surrounding condition recognition portion 15, a driving risk recognition portion 16, a driving risk recognition method switching portion 17, and a driving risk notification portion 18.

A process to be executed by the biometric information recognition portion 11 corresponds to a biometric information recognition step in a driver monitoring method of the present disclosure, and a process to be executed by the driving behavior recognition portion 12 corresponds to a driving behavior recognition step in the driver monitoring method of the present disclosure. A process to be executed by the driving risk recognition portion 16 corresponds to a driving risk recognition step in the driver monitoring method of the present disclosure, and a process to be executed by the driving risk recognition method switching portion 17 corresponds to a driving risk recognition method switching step in the driver monitoring method of the present disclosure.

The biometric information recognition portion 11 acquires, through communication with the wearable device 160, measurement information Bid related to a physical activity of the driver D measured by the wearable device 160, and thus recognizes biometric information of the driver D. The biometric information involves a heart rate, a sleep time, a quality of sleep (REM sleep, non-REM sleep, or a depth of sleep), an exercise status (the number of step, exercise time, or the like).

The driving behavior recognition portion 12 acquires measurement information Dri regarding the driving behavior of the driver D measured in the vehicle 100 through communication with the vehicle 100 and thus recognizes the driving behavior of the driver D. The measurement information Dri involves an operating speed of the accelerator pedal 141 detected by an accelerator pedal sensor, an operating speed of the brake pedal 142 detected by a brake pedal sensor, an operating speed of the steering wheel detected by a steering sensor, and left-right wobbles of the vehicle 100 detected by a yaw sensor. The driving behavior recognition portion 12 recognizes the driving behavior such as sudden acceleration, sudden deceleration, or abrupt steering, based on the measurement information Dri.

The moving body position recognition portion 13 recognizes the position (current position) of the vehicle 100 based on a position detection signal of the GNSS sensor 33. The movement history recognition portion 14 recognizes the movement history of the vehicle 100 by referring to the movement history data 22. The surrounding condition recognition portion 15 acquires surrounding information of the vehicle 100 recognized in the vehicle 100 through communication with the vehicle 100 and thus recognizes surrounding conditions of the vehicle 100. The surrounding information involves, for example, positions of objects (for example, pedestrians or other vehicles) existing in front of the vehicle 100 and recognized from an image captured by the front camera 130 of the vehicle 100, and positions of other vehicles recognized through vehicle-to-vehicle communication between the vehicle 100 and other vehicles surrounding the vehicle 100. The traffic information may be acquired through communication with the navigation device 121 provided in the vehicle 100.

The driving risk recognition portion 16 recognizes a driving risk indicating a risk level of movement of the vehicle 100 by the driving of the driver D. The driving risk recognition portion 16 recognizes a pre-driving risk, which is a driving risk before the driver D starts driving the vehicle 100, based on pre-driving biometric information, which is biometric information recognized by the biometric information recognition portion 11 before the driver D starts driving the vehicle 100.

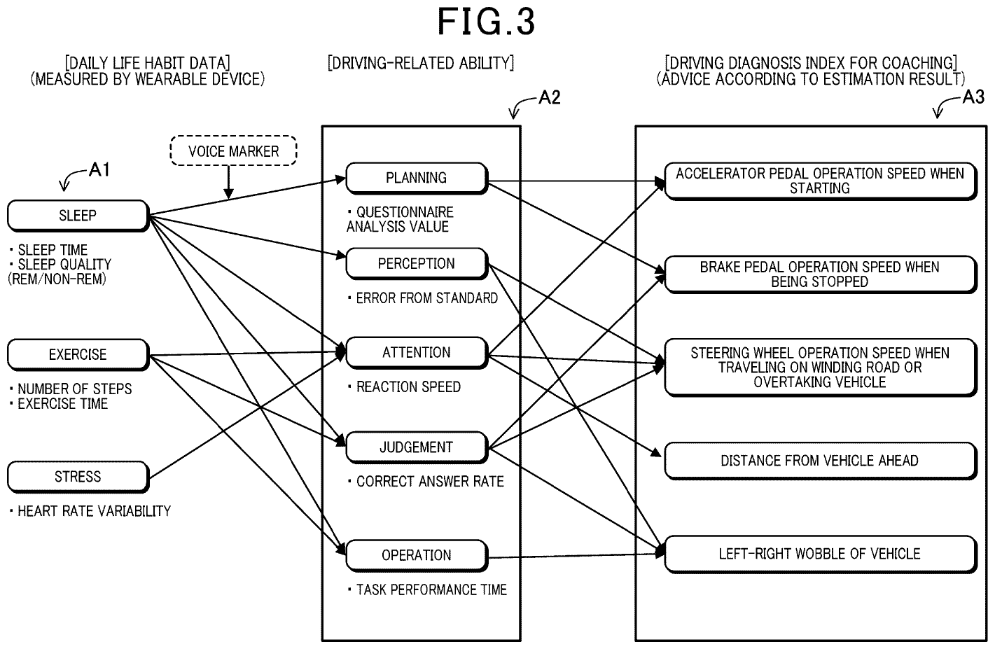

As shown in FIG. 3, the driving risk recognition portion 16 acquires, as factors that affect the driving-related abilities (planning, perception, attention, judgement, and operation) shown in A2, daily life habit data (sleep, exercise, or stress) of the driver D shown in A1 from the pre-driving biometric information, and recognizes pre-driving risks based on the daily life habit data. In addition, as the daily life habit data, voice data of the driver D acquired by a dialogue application executed by the wearable device 160 or the communication terminal 1 may be used as a voice marker to recognize the pre-driving risk of the driver D from results of voice analysis.

Regarding the driving-related abilities of A2, for example, the planning is evaluated by questionnaire analysis values, the perception is evaluated by an error from a standard, the attention is evaluated by a reaction speed, the judgement is evaluated by a correct answer rate, and the operation is evaluated by a task performance time. Regarding the daily life habit data of A1, the sloop includes a sleep time and a sleep quality (REM sleep, non-REM sleep), the exercise includes the number of steps and an exercise time, and the stress includes heart rate variability. The evaluation of the driving-related abilities is used as a driving diagnosis index for coaching to be notified to the driver D, as shown in A3.

The driving risk recognition portion 16 recognizes that the pre-driving risk is increasing, for example, in the following cases.

Pre-driving state 1: A case of being estimated from the heart rate variability of the driver D that the stress of the driver is increasing.

Pre-driving state 2: A case where the sleep time of the driver D is shorter than the former average.

Pre-driving state 3: A case where the exercise time of the driver D is shorter than the former average.

The driving risk recognition portion 16 recognizes the driving risk of the driver D, who is driving the vehicle 100, using a first recognition method or a second recognition method below.

First recognition method: The driving risk recognition portion 16 calculates the driving risk from Formula (1) below, based on the pre-driving risk of the driver D and the heart rate of the driver D, who is driving, recognized by the biometric information recognition portion 11.

$$Dr 1 ( t ) = α 1 \cdot Hr ( t ) + γ 1 \cdot PDr \qquad ( 1 )$$

Here, Dr1(t) represents the driving risk according to the first recognition method at a measurement time t, Hr(t) represents the heart rate of the driver D at a measurement time t, Hr represents the pre-driving risk, and α1 and γ1 represent adjustment coefficients.

In the first recognition method, since a driving risk is calculated without using information regarding driving behavior, the communication between the vehicle 100 and the communication terminal 1 is not required, and power consumption required to calculate the driving risk can be reduced compared to the following second recognition method.

Second recognition method: The driving risk recognition portion 16 calculates the driving risk from Formula (2) below, based on the pre-driving risk of the Driver D, the heart rate of the driver D, who is driving, recognized by the biometric information recognition portion 11, and the level (level value corresponding to the speed of exercise behavior) of the driving behavior of the driver D, who is driving, recognized by the driving behavior recognition portion 12.

$$Dr 2 ( t ) = α 2 \cdot Hr ( t ) + β \cdot Da ( t ) + γ 2 \cdot PDr \qquad ( 2 )$$

Here, Dr2(t) represents the driving risk according to the second recognition method at a measurement time t, Hr(t) represents the heart rate of the driver D at a measurement time t, Da(t) represents the driving behavior level of the driver D at a measurement time t, Hr represents the pre-driving risk, and α2, β, and γ2 represent adjustment coefficients.

Here, the driving risk recognition portion 16 may calculate the driving risk by applying various statistical models that are commonly used. For example, the driving risk may be calculated by a statistical process using a multiple logistic model.

The driving risk recognition method switching portion 17 switches the driving risk recognition method to be used by the driving risk recognition portion 16 at the next recognition time point, according to the driving risk recognized by the driving risk recognition portion 16. The driving risk notification portion 18 notifies the driver D of driving advice when the driving risk recognized by the driving risk recognition portion 16 is equal to or greater than a notification threshold.

### 3. Driving Risk Recognition Process

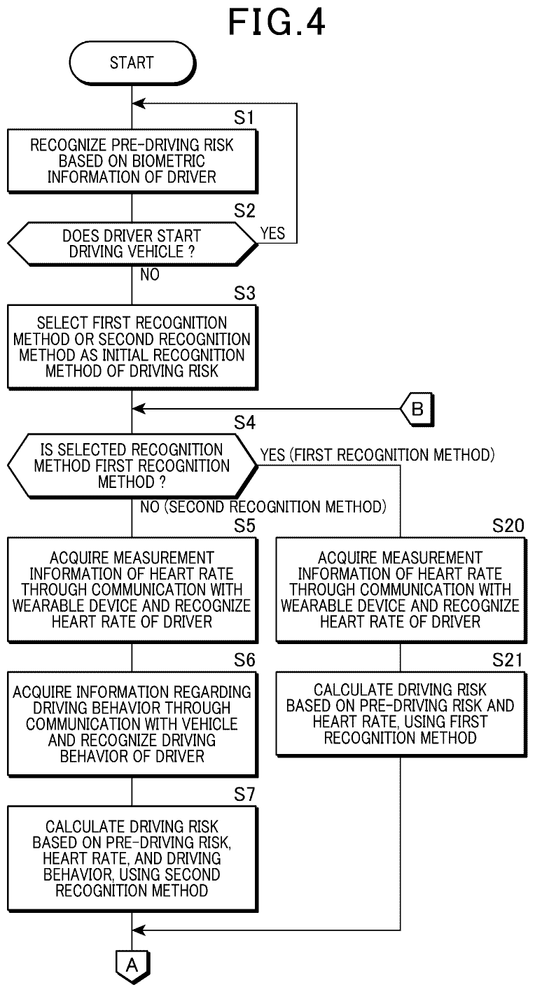

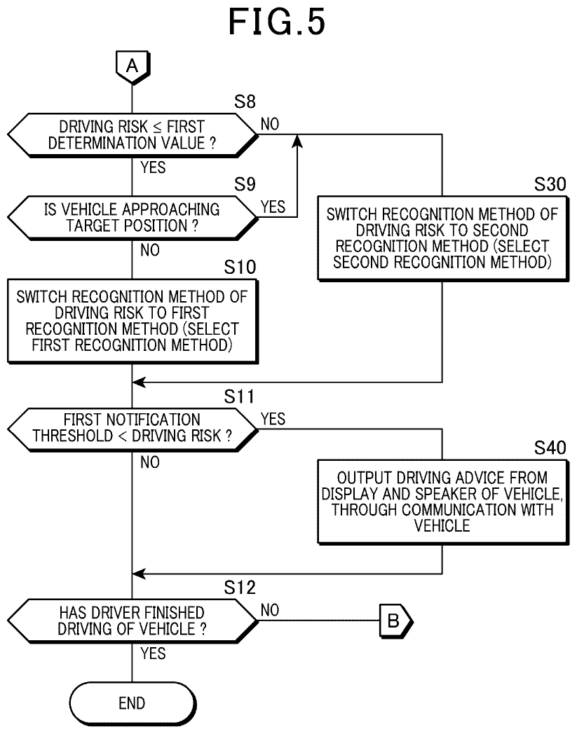

A procedure of a driving risk recognition process executed by the driver monitoring device 2 will be described with reference to flowcharts shown in FIGS. 4 and 5.

In steps S1 and S2 in FIG. 4, the driving risk recognition portion 16 repeatedly executes a process of recognizing a pre-driving risk in step S1 until it is recognized in step S2 that the driver D starts driving the vehicle 100, based on the biometric information recognized by the biometric information recognition portion 11 before the driver D starts driving the vehicle 100 as described above. The driving risk recognition portion 16 recognizes that the driver D starts driving the vehicle 100 through the communication with the vehicle 100.

In subsequent step S3, the driving risk recognition method switching portion 17 selects, as an initial recognition method of the driving risk, the first recognition method or the second recognition method described above. The driving risk recognition method switching portion 17 may determine whether to select either the first recognition method or the second recognition method as the initial recognition method according to the level of the pre-driving risk. Alternatively, either the first recognition method or the second recognition method may be fixed as the initial recognition method.

The process proceeds to step S20 when the recognition method selected by the driving risk recognition method switching portion 17 in subsequent step S4, is the first recognition method, and the process proceeds to step S5 when the selected recognition method is the second recognition method.

In step S20, the biometric information recognition portion 11 acquires measurement information Bid of the heart rate through communication with the wearable device 160, and recognizes the heart rate of the driver D. In subsequent step S21, the driving risk recognition portion 16 calculates, based on the pre-driving risk and the heart rate of the driver D, the driving risk of the driver D, who is driving, from Formula (1) above using the first recognition method, and the process proceeds to step S8 in FIG. 5.

In step S5, the biometric information recognition portion 11 acquires measurement information Bid of the heart rate through the communication with the wearable device 160, and recognizes the heart rate of the driver D. In subsequent step S6, the driving behavior recognition portion 12 acquires measurement information Dri of the driving behavior of the driver D through communication with the vehicle 100, and recognizes the driving behavior of the driver D. In subsequent step S7, the driving risk recognition portion 16 calculates, based on the pre-driving risk, the heart rate, and driving behavior of the driver D, the driving risk while driving, from Formula (2) above using the second recognition method.

In subsequent step S8 in FIG. 5, the driving risk recognition method switching portion 17 determines whether the driving risk of the driver D calculated by the driving risk recognition portion 16 is equal to or less than a first determination value. Then, when the driving risk recognition method switching portion 17 determines that the driving risk is equal to or smaller than the first determination value, the process proceeds to step S9, and when the driving risk is determined to be greater than the first determination value, the process proceeds to step S30.

In step S30, the driving risk recognition method switching portion 17 switches the driving risk recognition method to the second recognition method (selects the second recognition method), and the process proceeds to step S11. In step S9, the driving risk recognition method switching portion 17 determines whether the vehicle 100 is approaching a target position where unstable behavior has occurred in the past, based on the position of the vehicle 100 recognized by the moving body position recognition portion 13, the movement history of the vehicle 100 recognized by the movement history recognition portion 14, and map information involved in traffic information Trd acquired from traffic information server 210.

Then, when the driving risk recognition method switching portion 17 determines that the vehicle 100 has approached the target position, the process proceeds to step S30, and when the vehicle 100 is determined not to have approached the target position, the process proceeds to step S10. In step S10, the driving risk recognition method switching portion 17 switches the driving risk recognition method to the first recognition method (selects the first recognition method), and the process proceeds to step S11.

In step S11, the driving risk notification portion 18 determines whether the driving risk calculated by the driving risk recognition portion 16 is greater than a first notification threshold. Then, when the driving risk notification portion 18 determines that the driving risk is greater than the first notification threshold, the process proceeds to step S40, and when the driving risk is determined to be equal to or smaller than the first notification threshold, the process proceeds to step S12.

In step S40, the driving risk notification portion 18 communicates with the vehicle 100 to display driving advice on the display 132 of the vehicle 100 and to output the driving advice as audio from the speakers 133a and 133b of the vehicle 100, and the process proceeds to step S12. In step S12, the driving risk notification portion 18 determines whether the driver D has finished driving the vehicle 100. When it is determined that the driver D continues to drive the vehicle 100, the process proceeds to step S4 in FIG. 4, and when it is determined that the driver D has finished driving the vehicle 100, the process proceeds to step S13 and the driving risk recognition process ends.

### 4. Another Embodiment

In the above-described embodiment, the biometric information recognition portion 11 recognizes the heart rate as the biometric information of the driver D. In another embodiment, the biometric information recognition portion 11 may recognize, as the biometric information of the driver D, the blood pressure, the body temperature, or the like of the driver D detected by a vital sensor provided in the wearable device 160.

In addition, the biometric information recognition portion 11 may acquire detection information regarding the heart rate, the blood pressure, the body temperature, or the like detected by a vital sensor provided in the communication terminal 1 or the vehicle 100, to recognize the biometric information of the driver D.

In the above-described embodiment, the driving risk recognition portion 16 recognizes the pre-driving risk of the driver D and calculates the driving risk of the driver D, who is driving, using the pre-driving risk from Formulas (1) and (2). In another embodiment, the driving risk of the driver D, who is driving, may be calculated without using the pre-driving risk.

Furthermore, the driving risk recognition portion 16 may calculate the driving risk of the driver D, who is driving, by reflecting the surrounding conditions of the vehicle 100 recognized by the surrounding condition recognition portion 15.

In this case, the driving risk recognition portion 16 makes compensation such that the driving risk is increased, for example, when there is heavy traffic or when a distance from a preceding vehicle is short.

In the above-described embodiment, the moving body position recognition portion 13 and the movement history recognition portion 14 are provided, and the driving risk recognition method switching portion 17 switches the driving risk recognition method to the second recognition method when the vehicle 100 has approached the target position where unstable behavior has occurred in the past, in step S9 in FIG. 5. In another embodiment, the moving body position recognition portion 13 and the movement history recognition portion 14 may not be provided, and the process of switching to the second recognition method may not be performed when the vehicle 100 has approached the target position. Furthermore, when the vehicle 100 has approached the target position, the driving risk recognition portion 16 may increase the frequency of recognition of the driving risk.

In the above-described embodiment, the driving risk recognition method switching portion 17 switches the driving risk recognition method of the driver D between the first recognition method and the second recognition method. In another embodiment, when the driving risk recognition portion 16 recognizes the driving risk equal to or greater than a second determination value that is greater than the first determination value, the driving risk recognition method may switch the recognition method of the driving risk to a third recognition method in which the driving risk is recognized based on the biometric information and the driving behavior of the driver D and in which the frequency at which the biometric information recognition portion 11 recognizes the biometric information of the driver D and the frequency at which the driving behavior recognition portion 12 recognizes the driving behavior of the driver D are higher than that in the second recognition method.

In the above-described embodiment, through steps S11 and step S12 in FIG. 5, when it is determined that the driving risk is greater than the first notification threshold, the driving risk notification portion 18 outputs the driving advice from the display 132 and the speakers 133a and 133b provided in the vehicle 100. In another embodiment, the frequency of outputting the driving advice when the driving risk is equal to or greater than a second notification threshold that is greater than the first notification threshold may be set to be higher than that when the driving risk is equal to or smaller than the second notification threshold.

When the driving risk is greater than the second notification threshold, the driving advice may be output from the display 132 and the speakers 133a and 133b provided in the vehicle 100, and when the driving risk is equal to or smaller than the second notification threshold, the driving advice may be output from the display 34 and the speaker 35 in the communication terminal 1.

In the above-described embodiment, the driver monitoring device 2 is configured as a function of the communication terminal 1. In another embodiment, the driver monitoring device of the present disclosure may be configured as a function of an in-vehicle device such as ECU 110 provided in the vehicle 100, or as a dedicated in-vehicle device. In this case, the in-vehicle device communicates with the wearable device 160 worn by the driver D to receive biometric information measurement information Bid and to recognize biometric information.

The driver monitoring device of the present disclosure may be configured as a function of a server such as the vehicle management server 211. In this case, the server receives biometric information measurement information Bid and recognizes biometric information through communication with the wearable device 160 worn by the driver D (direct communication or communication via the communication terminal 1 or the vehicle 100).

FIG. 2 is a schematic diagram illustrating the configuration of the driver monitoring device 2 by dividing the configuration according to main process contents to facilitate understanding of the present invention, and the configuration of the driver monitoring device 2 may be divided according to other categories. The process of each of the components may be executed by one hardware unit, or may be executed by a plurality of hardware units. Further, the process of each of the components illustrated in FIGS. 4 and 5 may be executed by one program, or may be executed by a plurality of programs.

### 5. Configuration Supported by Embodiment

The above-described embodiment is a specific example of the following configuration.

(Configuration 1) A driver monitoring device including: a biometric information recognition portion that recognizes biometric information of a driver of a moving body; a driving behavior recognition portion that recognizes driving behavior of the driver, who is driving the moving body; a driving risk recognition portion that recognizes, using a predetermined recognition method, a driving risk indicating a risk level of movement of the moving body due to driving of the driver, based on at least one of the biometric information of the driver recognized by the biometric information recognition portion and the driving behavior of the driver recognized by the driving behavior recognition portion, when the driver is driving the moving body; and a driving risk recognition method switching portion that switches the recognition method used when the driving risk recognition portion recognizes the driving risk at a next recognition timing, according to the driving risk recognized by the driving risk recognition portion.

According to the driver monitoring device of Configuration 1, the recognition method to be used is switched when the driving risk is recognized depending on the driving risk, whereby it is possible to reduce the power consumption for recognizing the biometric information or the driving behavior used in the recognition method and to recognize the driving risk, which is the risk level of the driving situation with which the driver is confronted.

(Configuration 2) In the driver monitoring device according to Configuration 1, the driving risk recognition portion recognizes a pre-driving risk, which is the driving risk before the driver starts driving the moving body, based on the biometric information of the driver recognized by the biometric information recognition portion before the driver starts driving the moving body, and the driving risk recognition method switching portion switches the recognition method based on the pre-driving risk.

According to the driver monitoring device of Configuration 2, the recognition method is switched based on the pre-driving risk, whereby the recognition method can be switched to reflect health conditions of the driver at the time of driving.

(Configuration 3) In the driver monitoring device according to Configuration 1 or 2, the driving risk recognition method switching portion switches the recognition method to a first recognition method of recognizing the driving risk based on the biometric information of the driver without using the driving behavior of the driver when the driving risk recognized by the driving risk recognition portion is equal to or smaller than a first determination value, and the driving risk recognition method switching portion switches the recognition method to a second recognition method of recognizing the driving risk based on the driving behavior and the biometric information of the driver when the driving risk recognized by the driving risk recognition portion is greater than the first determination value.

According to the driver monitoring device of Configuration 3, the driving behavior recognition portion does not recognize the driving behavior and the next driving risk is recognized when the driving risk is equal to or smaller than the first determination value, whereby the driving behavior recognition portion can recognize the driving risk without requiring power consumption (power consumption required for communication, calculation processing, or the like) when recognizing the driving behavior.

(Configuration 4) In the driver monitoring device according to any one of Configurations 1 to 3, the driver monitoring device further includes a driving risk notification portion that outputs a predetermined notification from an output device used by the driver when the driving risk recognition portion recognizes the driving risk that is greater than a first notification threshold.

According to the driver monitoring device of Configuration 4, a predetermined notification is issued when the driving risk is greater than the first notification threshold, whereby the driver can be prompted to take action in response to the increased driving risk.

(Configuration 5) In the driver monitoring device according to Configuration 3, the driver monitoring device further includes: a moving body position recognition portion that recognizes a position of the moving body; and a movement history recognition portion that recognizes a former movement history of the moving body, and the driving risk recognition portion recognizes the driving risk that is equal to or smaller than the first determination value, and increases a frequency of recognizing the driving risk when the moving body position recognition portion recognizes that the moving body is approaching a target position where the movement history recognition portion recognizes that the moving body formerly exhibited predetermined unstable behavior.

According to the driver monitoring device of Configuration 5, when the moving body has approached the target position where the driver performs emergency operation causing unstable behavior of the moving body in the past and thus it is estimated that the driver's stress increases, the recognition frequency of the driving risk increases, and thus changes in driving risk in response to the increase in the driver's stress can be recognized quickly.

(Configuration 6) In the driver monitoring device according to Configuration 3, the driver monitoring device further includes: a moving body position recognition portion that recognizes a position of the moving body; and a movement history recognition portion that recognizes a former movement history of the moving body, and the driving risk recognition method switching portion switches the recognition method to the second recognition method when the driving risk recognition portion recognizes the driving risk that is equal to or smaller than the first determination value and the moving body position recognition portion recognizes that the moving body is approaching a target position where the movement history recognition portion recognizes that the moving body formerly exhibited predetermined unstable behavior.

According to the driver monitoring device of Configuration 6, when the moving body has approached the target position where the driver performs emergency operation causing unstable behavior of the moving body in the past and thus it is estimated that the driver's stress increases, the recognition method of the driving risk is switched to the second recognition method, thereby making it possible to accurately recognize changes in driving risk in response to the increase in the driver's stress.

(Configuration 7) In the driver monitoring device according to Configuration 3, the driving risk recognition method switching portion switches, when the driving risk recognition portion recognizes the driving risk equal to or greater than a second determination value that is greater than the first determination, the recognition method to a third recognition method in which the driving risk is recognized based on the biometric information and the driving behavior of the driver and in which a frequency at which the biometric information recognition portion recognizes the biometric information of the driver and a frequency at which the driving behavior recognition portion recognizes the driving behavior of the driver are higher than those in the second recognition method.

According to the driver monitoring device of Configuration 7, when the driving risk is equal to or higher than the second determination value, the recognition method is switched to the third recognition method in which the frequency of recognizing the biometric information and the driving behavior is high, whereby it is possible to quickly recognize changes in driving risk in situations where the driving risk increases.

(Configuration 8) In the driver monitoring device according to Configuration 7, the driver monitoring device further includes a surrounding condition recognition portion that recognizes a surrounding condition of the moving body based on a result detected by an external sensor provided in the moving body, and the third recognition method recognizes the driving risk based on the surrounding condition of the moving body recognized by the surrounding condition recognition portion.

According to the driver monitoring device of Configuration 8, it is possible to improve the accuracy of recognizing the driving risk, using the surrounding conditions of the moving body detected by an external sensor.

(Configuration 9) In the driver monitoring device according to Configuration 4, when the driving risk recognized by the driving risk recognition portion is equal to or greater than a second notification threshold that is greater than the first notification threshold, the driving risk notification portion outputs the predetermined notification from the output device at a higher frequency than when the driving risk recognized by the driving risk recognition portion is smaller than the second notification threshold.

According to the driver monitoring device of Configuration 9, the frequency of outputting a predetermined notification from the output device increases when the driving risk increases to the second notification threshold or higher, whereby it is possible to improve the effect of the notification to the driver.

(Configuration 10) In the driver monitoring device according to Configuration 4 or 9, when the driving risk recognized by the driving risk recognition portion is equal to or greater than a second notification threshold that is greater than the first notification threshold, the driving risk notification portion transmits the predetermined notification to a communication device external to the moving body.

According to the driver monitoring device of Configuration 10, a predetermined notification is transmitted to an external communication device (a communication terminal used by the driver's family members, a server system that supports the use of the moving body, a communication device used by other moving bodies surrounding the moving body, or the like) when the driving risk increases to the second notification threshold or higher, whereby it is possible to request the support for the driver.

(Configuration 11) A driver monitoring method executed by a computer, the driver monitoring method including: a biometric information recognition step of recognizing biometric information of a driver of a moving body; a driving behavior recognition step of recognizing driving behavior of the driver, who is driving the moving body; a driving risk recognition step of recognizing, using a predetermined recognition method, a driving risk indicating a risk level of movement of the moving body due to driving of the driver, based on at least one of the biometric information of the driver recognized in the biometric information recognition step and the driving behavior of the driver recognized in the driving behavior recognition step, when the driver is driving the moving body; and a driving risk recognition method switching step of switching the recognition method used when the driving risk is recognized at a next recognition timing in the driving risk recognition step, according to the driving risk recognized in the driving risk recognition step.

The computer executes the driver monitoring method of Configuration 11, whereby it is possible to obtain the same operational effect as the driver monitoring device of Configuration 1.

(Configuration 12) A non-transitory computer-readable storage medium storing a program causing a computer to function as: a biometric information recognition portion that recognizes biometric information of a driver of a moving body; a driving behavior recognition portion that recognizes driving behavior of the driver, who is driving the moving body; a driving risk recognition portion that recognizes, using a predetermined recognition method, a driving risk indicating a risk level of movement of the moving body due to driving of the driver, based on at least one of the biometric information of the driver recognized by the biometric information recognition portion and the driving behavior of the driver recognized by the driving behavior recognition portion, when the driver is driving the moving body; and a driving risk recognition method switching portion that switches the recognition method used when the driving risk recognition portion recognizes the driving risk at a next recognition timing, according to the driving risk recognized by the driving risk recognition portion.

The computer executes the program of Configuration 12, whereby it is possible to implement the configuration of the driver monitoring device of Configuration 1.

### REFERENCE SIGNS LIST

1 communication terminal
2 driver monitoring device
10 processor
11 biometric information recognition portion
12 driving behavior recognition portion
13 moving body position recognition portion
14 movement history recognition portion
15 surrounding condition recognition portion
16 driving risk recognition portion
17 driving risk recognition method switching portion
18 driving risk notification portion
20 memory
21 program
22 movement history data
30 communication unit
31 camera
32 acceleration sensor
33 GNSS sensor
34 display
35 speaker
100 vehicle
110 ECU
120 communication unit
121 navigation device
130 front camera
131 driver monitor camera
132 display
133a, 133b speaker
150 terminal holder
160 wearable device
200 communication network
210 traffic information server
211 vehicle management server
D driver

1. A driver monitoring device comprising:
a biometric information recognition portion that recognizes biometric information of a driver of a moving body;
a driving behavior recognition portion that recognizes driving behavior of the driver, who is driving the moving body;
a driving risk recognition portion that recognizes, using a predetermined recognition method, a driving risk indicating a risk level of movement of the moving body due to driving of the driver, based on at least one of the biometric information of the driver recognized by the biometric information recognition portion and the driving behavior of the driver recognized by the driving behavior recognition portion, when the driver is driving the moving body; and
a driving risk recognition method switching portion that switches the recognition method used when the driving risk recognition portion recognizes the driving risk at a next recognition timing, according to the driving risk recognized by the driving risk recognition portion.

2. The driver monitoring device according to claim 1, wherein
the driving risk recognition portion recognizes a pre-driving risk, which is the driving risk before the driver starts driving the moving body, based on the biometric information of the driver recognized by the biometric information recognition portion before the driver starts driving the moving body, and
the driving risk recognition method switching portion switches the recognition method based on the pre-driving risk.

3. The driver monitoring device according to claim 1, wherein
the driving risk recognition method switching portion switches the recognition method to a first recognition method of recognizing the driving risk based on the biometric information of the driver without using the driving behavior of the driver when the driving risk recognized by the driving risk recognition portion is equal to or smaller than a first determination value, and
the driving risk recognition method switching portion switches the recognition method to a second recognition method of recognizing the driving risk based on the driving behavior and the biometric information of the driver when the driving risk recognized by the driving risk recognition portion is greater than the first determination value.

4. The driver monitoring device according to claim 1, further comprising a driving risk notification portion that outputs a predetermined notification from an output device used by the driver when the driving risk recognition portion recognizes the driving risk that is greater than a first notification threshold.

5. The driver monitoring device according to claim 3, further comprising:
a moving body position recognition portion that recognizes a position of the moving body; and
a movement history recognition portion that recognizes a former movement history of the moving body, wherein
the driving risk recognition portion recognizes the driving risk that is equal to or smaller than the first determination value, and increases a frequency of recognizing the driving risk when the moving body position recognition portion recognizes that the moving body is approaching a target position where the movement history recognition portion recognizes that the moving body formerly exhibited predetermined unstable behavior.

6. The driver monitoring device according to claim 3, further comprising:
a moving body position recognition portion that recognizes a position of the moving body; and
a movement history recognition portion that recognizes a former movement history of the moving body, wherein
the driving risk recognition method switching portion switches the recognition method to the second recognition method when the driving risk recognition portion recognizes the driving risk that is equal to or smaller than the first determination value and the moving body position recognition portion recognizes that the moving body is approaching a target position where the movement history recognition portion recognizes that the moving body formerly exhibited predetermined unstable behavior.

7. The driver monitoring device according to claim 3, wherein
the driving risk recognition method switching portion switches, when the driving risk recognition portion recognizes the driving risk equal to or greater than a second determination value that is greater than the first determination, the recognition method to a third recognition method in which the driving risk is recognized based on the biometric information and the driving behavior of the driver and in which a frequency at which the biometric information recognition portion recognizes the biometric information of the driver and a frequency at which the driving behavior recognition portion recognizes the driving behavior of the driver are higher than those in the second recognition method.

8. The driver monitoring device according to claim 7, further comprising a surrounding condition recognition portion that recognizes a surrounding condition of the moving body based on a result detected by an external sensor provided in the moving body, wherein
the third recognition method recognizes the driving risk based on the surrounding condition of the moving body recognized by the surrounding condition recognition portion.

9. The driver monitoring device according to claim 4, wherein
when the driving risk recognized by the driving risk recognition portion is equal to or greater than a second notification threshold that is greater than the first notification threshold, the driving risk notification portion outputs the predetermined notification from the output device at a higher frequency than when the driving risk recognized by the driving risk recognition portion is smaller than the second notification threshold.

10. The driver monitoring device according to claim 4, wherein
when the driving risk recognized by the driving risk recognition portion is equal to or greater than a second notification threshold that is greater than the first notification threshold, the driving risk notification portion outputs the predetermined notification from the output device provided in the moving body.

11. A driver monitoring method executed by a computer, the driver monitoring method comprising:
a biometric information recognition step of recognizing biometric information of a driver of a moving body;
a driving behavior recognition step of recognizing driving behavior of the driver, who is driving the moving body;
a driving risk recognition step of recognizing, using a predetermined recognition method, a driving risk indicating a risk level of movement of the moving body due to driving of the driver, based on at least one of the biometric information of the driver recognized in the biometric information recognition step and the driving behavior of the driver recognized in the driving behavior recognition step, when the driver is driving the moving body; and
a driving risk recognition method switching step of switching the recognition method used when the driving risk is recognized at a next recognition timing in the driving risk recognition step, according to the driving risk recognized in the driving risk recognition step.

12. A non-transitory computer-readable storage medium storing a program causing a computer to function as:
a biometric information recognition portion that recognizes biometric information of a driver of a moving body;
a driving behavior recognition portion that recognizes driving behavior of the driver, who is driving the moving body;
a driving risk recognition portion that recognizes, using a predetermined recognition method, a driving risk indicating a risk level of movement of the moving body due to driving of the driver, based on at least one of the biometric information of the driver recognized by the biometric information recognition portion and the driving behavior of the driver recognized by the driving behavior recognition portion, when the driver is driving the moving body; and
a driving risk recognition method switching portion that switches the recognition method used when the driving risk recognition portion recognizes the driving risk at a next recognition timing, according to the driving risk recognized by the driving risk recognition portion.
